(19) United States
(12) Patent Application Publication
(10) Pub. No.: US 2026/0131840 A1
(43) Pub. Date: May 14, 2026

(54) ELECTRIC CART

(71) Applicant: TILTA INC., Burbank, CA (US)

(72) Inventors: Sen WU, Shenzhen (CN); Weihan SHE, Shenzhen (CN); Wenping ZENG, Shenzhen (CN); Kefeng ZHOU, Shenzhen (CN)

(21) Appl. No.: 19/385,910

(22) Filed: Nov. 11, 2025

(30) Foreign Application Priority Data
Nov. 14, 2024 (CN) 202422782557.7

(51) Int. Cl. B62B 5/00; B62B 5/04; B62B 5/06

(52) U.S. Cl. CPC B62B 5/0073; B62B 5/0447; B62B 5/06; B62B 5/0033; B62B 5/0053

(57) ABSTRACT

An electric cart includes a cart body, a drive assembly, and a control assembly. The cart body is equipped with wheels at its bottom. The drive assembly is mounted on the cart body and electrically connected to the wheels, while the control assembly is in communication with the drive assembly to regulate its operation, thereby driving the wheels to move. Users can operate the control assembly to control the drive assembly, which in turn drives the wheels to rotate, providing power for the cart's movement and enabling electric travel according to the user's commands. This design significantly reduces the user's physical exertion and enhances convenience in moving the cart.

### CROSS-REFERENCE TO RELATED APPLICATIONS

The present application for patent claims priority to and the benefit of pending Chinese Application No. 202422782557.7, filed November 14, 2024, and hereby expressly incorporated by reference herein as if fully set forth below in its entirety and for all applicable purposes.

### TECHNICAL FIELD

The present disclosure pertains to the technical field of carts, specifically relating to an electric cart.

### INTRODUCTION

In the realm of filming and photography, various shooting tools and equipment are frequently employed. Users typically utilize mobile tools, such as carts, to facilitate their work. These carts enable users to place or store shooting tools and then transport or transfer them as needed by pushing or pulling the cart. However, most current carts are manually operated, requiring users to exert physical force on the handle to move the cart, which can be relatively strenuous and inconvenient.

### BRIEF SUMMARY

Aspects of the present disclosure provide an electric cart capable of electrically controlling its movement, thereby minimizing the user's physical effort and enhancing convenience.

Some aspects of the present disclosure provide: an electric cart, including: a cart body with a plurality of wheels provided at its bottom; a drive assembly mounted on the cart body and electrically connected to one or more of the wheels; and a control assembly in communication with the drive assembly to control its operation, thereby driving one or more of the wheels to move.

Regarding this electric cart, users can operate the control assembly to control the drive assembly, which drives one or more of the wheels to rotate, providing power for the cart's movement and enabling electric travel according to the user's commands. This design significantly reduces the user's physical exertion and enhances convenience in moving the cart.

### BRIEF DESCRIPTION OF THE DRAWINGS

To elucidate the various aspects of the present disclosure, the accompanying drawings for describing various exemplary embodiments will be briefly introduced below. It is apparent that the accompanying drawings described herein represent merely some embodiments of the present disclosure. For those skilled in the art, without the necessity for inventive effort, additional drawings and variations can be derived based on the structures depicted in these drawings.

FIG. 1 is a schematic diagram illustrating an electric cart according to some aspects of the disclosure.

FIG. 2 is an exploded view illustrating a pushing part equipped with a control assembly according to some aspects of the disclosure.

FIG. 3 is an enlarged schematic view of area A in FIG. 2.

FIG. 4 is another exploded view of the pushing part equipped with the control assembly according to some aspects of the disclosure.

FIG. 5 is an enlarged schematic view of area B in FIG. 4 according to some aspects of the disclosure.

FIG. 6 is another exploded view of the pushing part equipped with the control assembly according to some aspects of the disclosure.

FIG. 7 is an enlarged schematic view of area C in FIG. 6 according to some aspects of the disclosure.

FIG. 8 is a schematic diagram illustrating a drive assembly according to some aspects of the disclosure.

FIG. 9 is a schematic diagram illustrating the electric cart described according to some aspects of the disclosure.

### Reference Numerals

1 Electric cart;

10 Cart body;

11. Wheel;

12. Support column;

13. Storage platform;

14. Pushing part;

141. Handrail area;

142. Installation area;

1421. Control switch;

1422. Waterproof gasket;

1423. First housing;

1424. Second housing;

1425. Mounting chamber;

1426. Limiting groove;

143. Tube clamp;

1431. First clamping part;

1432. Second clamping part;

14321. Opening;

144. Locking member;

1441. Locking lever;

1442. Connecting shaft;

2 Drive assembly;

21. Second communication antenna;

22. Drive unit;

221. First drive unit;

222. Second drive unit;

23. Power supply unit;

3 Control assembly;

31. Operating member;

311. Operating part;

3111. Accommodating groove;

3112. Positioning protrusion;

3113. Finger grip;

312. Trigger part;

32. Control unit;

321. Main control unit;

322. Inductive sensor;

33. First communication antenna;

34. Battery compartment;

341. Battery cover;

342. Unlocking latch;

35. Power switch;

4 Elastic member.

### DETAILED DESCRIPTION

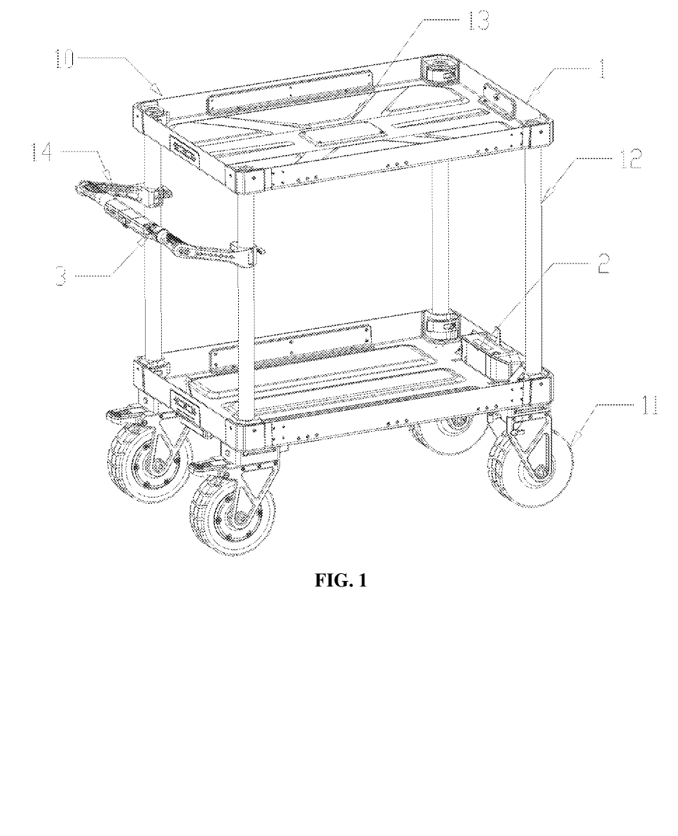

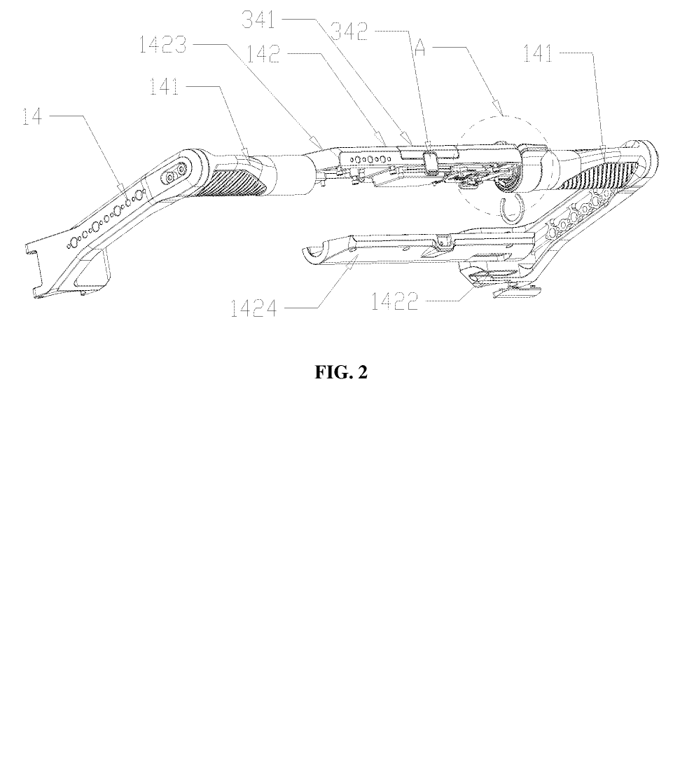

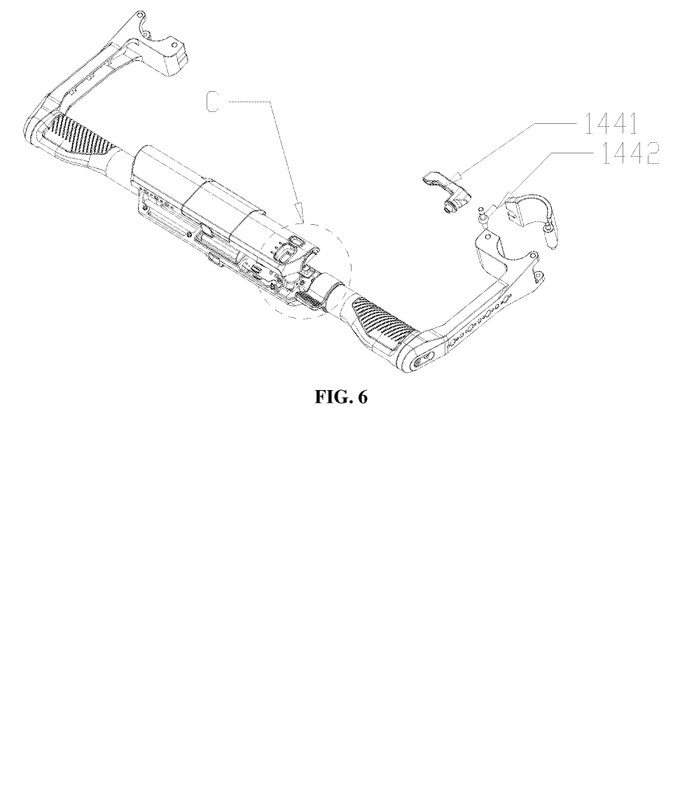

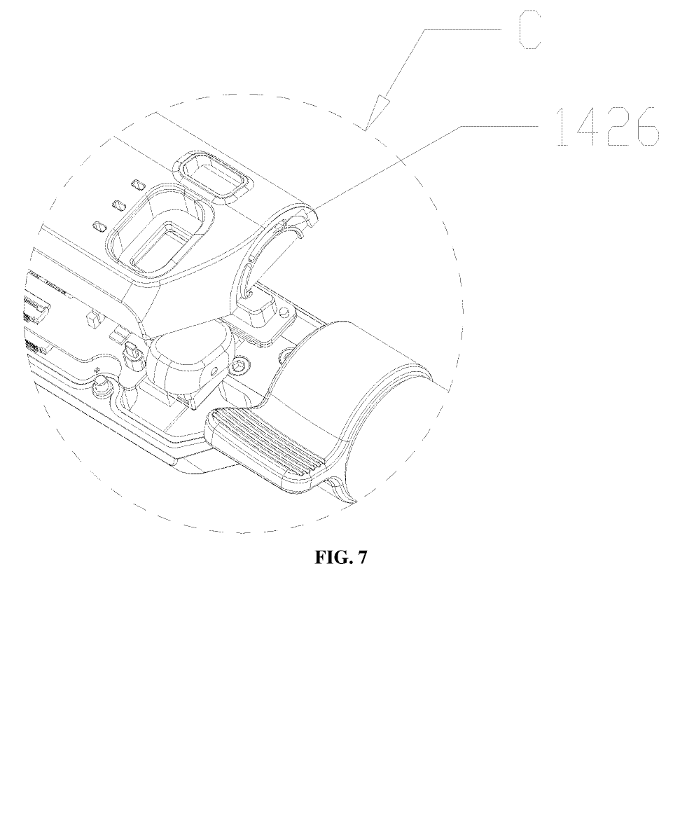

Referring to FIGS. 1-9, this disclosure presents an electric cart 10, including a cart body 1, a drive assembly 2, and a control assembly 3. The cart body 1 is equipped with wheels 11 at its bottom. The drive assembly 2 is mounted on the cart body 1 and electrically connected to the wheels 11, while the control assembly 3 is in communication with the drive assembly 2 to control its operation, thereby driving the wheels 11 to move.

Regarding this electric cart 10, users can operate the control assembly 3 to control the drive assembly 2, which drives the wheels 11 to rotate, providing power for the movement of electric cart and enabling electric propulsion according to the user's commands. This design significantly reduces the physical effort required from the user and enhances convenience in moving the cart.

In some aspects, the drive assembly 2 can be electrically connected to a built-in hub motor of one or more of the wheels 11, driving the motor to rotate and thus moving the wheels 11. The drive assembly 2 can include a circuit board mounted on the cart body 1, including a drive control device for driving the hub motor to rotate. The control assembly 3 can include a control device that receives the operation signal of the user and sends a corresponding signal to the drive assembly to drive the hub motor to rotate.

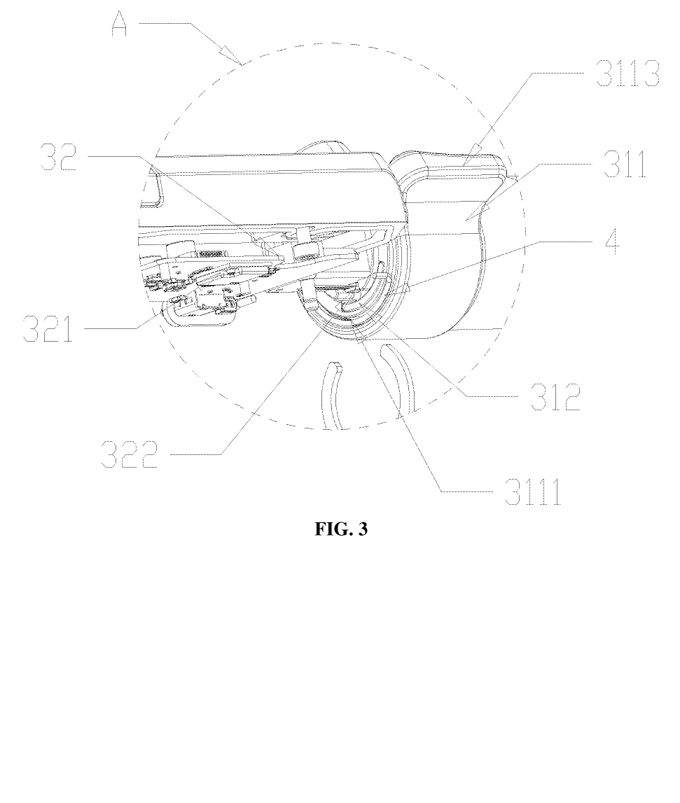

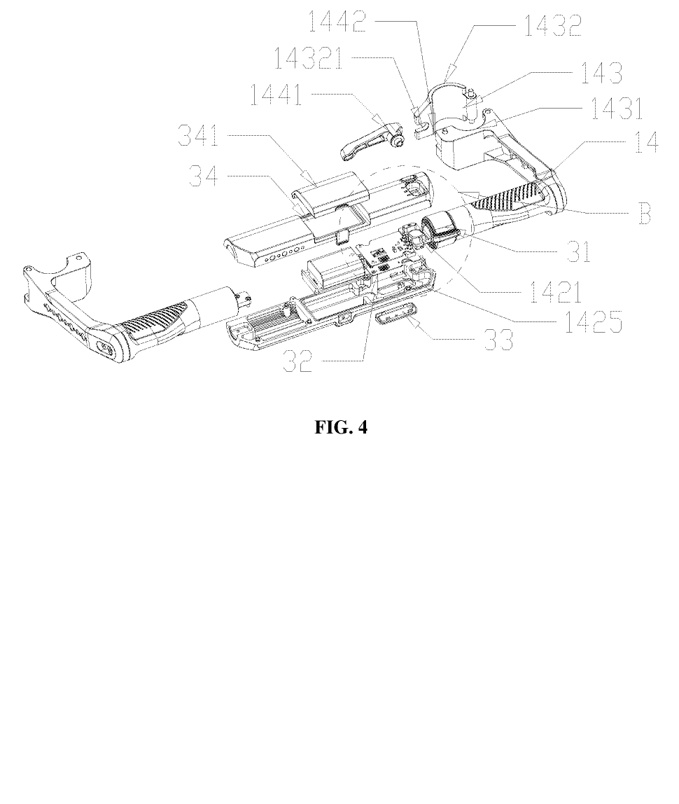

In some aspects, referring to FIGS. 3-4, the control assembly 3 includes an operating member 31 and a control unit 32. The control unit 32 senses the operation instruction of the operating member 31 to control the drive assembly 2. The operating member 31 can be a device manually operated by the user, capable of indicating (e.g., a control signal) the user's hand operation to the control unit 32, enabling the control unit 32 to obtain the control signal and, according to the control signal, control the drive assembly 2 to drive the hub motor to rotate, causing the wheels 11 to turn.

In some aspects, referring to FIG. 3, the control unit 32 includes a main control unit 321 (e.g., a controller) and an inductive sensor 322. The inductive sensor 322 is electrically connected to the main control unit 321. The operating member 31 includes an operating part 311 and a trigger part 312. The operating part 311 can be adapted to receive user input, and the trigger part 312 can be adapted to initiate an operational response based on the received input. For example, the trigger part 312 is connected to the operating part 311, which can drive the trigger part 312 to move in response to an input to the operating part 311. The inductive sensor 322 can sense or detect the movement of the trigger part 312, and the main control unit 321 can control the drive assembly 2 according to the sensing (e.g., sensing signal) of the inductive sensor 322. With this arrangement, when the user triggers the operating part 311 (e.g., a twist throttle), the trigger part 312 can move relative to the inductive sensor 322, causing the inductive sensor 322 to generate a corresponding response signal. The main control unit 321 can receive this response signal and control the drive assembly 2 to control the rotation of the hub motor or wheels 11. In some aspects, the trigger part 312 can include a magnet, and the inductive sensor 322 can include a Hall-effect sensor, specifically a linear Hall-effect sensor, which can be used to indicate magnetic field strength. The magnet is connected to the operating part 311, and the Hall-effect sensor is arranged on a pushing part 14 and is disposed opposite to the magnet.

In some aspects, the cart body 1 is provided with the pushing part 14, on which the main control unit 321 is arranged. The operating part 311 is movably arranged on the pushing part 14, enabling the user to hold the pushing part 14 and operate the operating part 311. The operating part 311 drives the magnet to move relative to the linear Hall-effect sensor, causing the linear Hall-effect sensor to output a response signal. In response to the response signal from the Hall-effect sensor, the main control module controls the movement of the cart, such as forward movement, reverse, etc. Simultaneously, the user can adjust the turning direction of the cart via the pushing part 14, enabling the cart to turn, etc.

In some aspects, the operating part 311 can include an elastic member 4. The operating part 311 has an accommodating groove 3111, in which the elastic member 4 is arranged, with one end abutting against or connected to the pushing part 14 and the other end abutting against or connected to the operating part 311, so that the operating part 311 is elastically connected to the pushing part 14. The elastic member 4 is used to allow the operating part 311 to reset. When the user releases the operating part 311, the operating part 311 can reset relative to the pushing part 14.

Referring to FIG. 1, in some aspects, the cart body 1 includes a plurality of storage platforms 13 and a plurality of support columns 12. The storage platforms 13 are installed on the support columns 12 sequentially along the height direction of the support columns 12. The pushing part 14 is connected to the support columns 12, and it is operatable by a user to push the cart body 1 to move. In some aspects, the pushing part 14 includes a handle, which includes a handrail rod and connecting rods connected to both ends of the handrail rod. The ends of the connecting rods away from the handrail rod are connected to the support columns 12, and the main control unit 321 is arranged on the handrail rod. The operating part 311 is movably arranged on the handrail rod. In some aspects, the handrail rod includes a plurality of handrail areas 141 and an installation area 142. For example, the installation area 142 is arranged between two of the handrail areas 141, and the main control unit 321 is arranged in the installation area 142. The operating part 311 is movably arranged at an end of one handrail area 141 close to the installation area 142 and is adjacent to the handrail area 141. The user can hold the corresponding handrail areas 141 with both hands and rotate the operating part 311, causing the magnet to rotate accordingly. The linear Hall-effect sensor can be arranged in the installation area 142 and extends into the handrail area 141 to be able to sense the rotation of the magnet. The main control module controls the movement of the wheels 11 according to the sensing signal of the linear Hall-effect sensor.

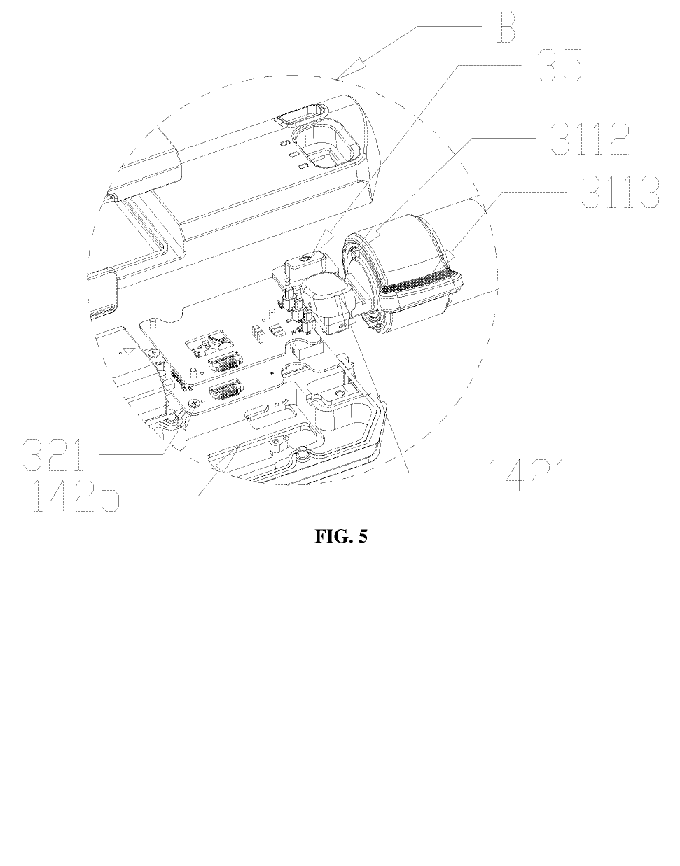

Referring to FIGS. 4-5, the installation area 142 can be provided with a control switch 1421, which is electrically connected to the main control unit 321 and has three gears or modes: forward, reverse, and brake. A user can use the control switch 1421 to switch between forward, reverse, and brake. For example, the user can set the control switch 1421 to the forward gear and then rotate the operating part 311, at which time the cart body 1 can travel forward. The installation area 142 can be equipped with a battery compartment 34 for installing a battery. After the battery is installed in the battery compartment 34, the battery can supply power to the control assembly 3. The battery compartment 34 is rotatably covered with a battery cover 341, and the installation area 142 can be elastically provided with an unlocking latch 342, which can lock the battery cover 341, enabling the battery cover 341 to cover the battery compartment 34. The various connection points in the installation area 142, such as the connection point of the battery cover 341, can be provided with waterproof gaskets 1422. The installation area 142 includes a first housing 1423 and a second housing 1424, which form a mounting chamber 1425. The main control unit 321 is installed inside the mounting chamber 1425, and a waterproof gasket 1422 (e.g., a ring gasket) is arranged between the first housing 1423 and the second housing 1424. In some aspects, both the pushing part 14 and the drive assembly 2 can be correspondingly provided with power switches 35. The power switch 35 on the pushing part 14 is electrically connected to the main control unit 321 and is used to control power on and off, while the power switch 35 on the drive assembly 2 is electrically connected to the drive assembly 2 and is used to control power on and off.

Referring to FIGS. 5-7, in some embodiments, an end of the installation area 142 near the operating part 311 is provided with a limiting groove 1426, and the operating part 311 has a positioning protrusion 3112, which is accommodated in the limiting groove 1426. The limiting groove 1426 can limit the positioning protrusion 3112 to provide rotational limitation for the operating part 311. In some aspects, a gasket, such as a plastic (e.g., polyoxymethylene (POM)) gasket, is arranged at the opposing portions of the installation area 142 and the operating part 311, serving a wear-resistant function.

In some aspects, the pushing part 14 is provided with a tube clamp 143 and a locking member 144. The tube clamp 143 includes a first clamping part 1431 and a second clamping part 1432. One end of the first clamping part 1431 and one end of the second clamping part 1432 are movably hinged to each other, and the other ends are lockingly connected by the locking member 144. In some aspects, the locking member 144 includes a locking lever 1441 and a connecting shaft 1442. The second clamping part 1432 has an opening 14321. The connecting shaft 1442 is movably connected to the first clamping part 1431 via a pivot pin, and its other end is threadedly connected to the locking lever 1441. The user can place the connecting shaft 1442 into the opening 14321 and then rotate the locking lever 1441 to abut tightly against the second clamping part 1432, causing the first clamping part 1431 and the second clamping part 1432 to clamp tightly onto the support column 12.

In some aspects, the operating part 311 can include various components such as a knob, a push rod, a toggle lever, etc. Taking a knob as an example, the pushing part 14 includes a handle. The knob is rotatably and elastically connected to the handle. When the user twists the knob, the main control module controls the cart body 1 to move forward at different speeds according to the degree of rotation of the knob. The outer wall of the operating part 311 can be provided with a finger grip 3113 to facilitate the user in rotating the operating part 311.

In some aspects, the control assembly 3 is provided with a first communication antenna 33, and the drive assembly 2 is provided with a second communication antenna 21. The first communication antenna 33 and the second communication antenna 21 can communicate, enabling the drive assembly 2 and the control assembly 3 to be in communicative connection.

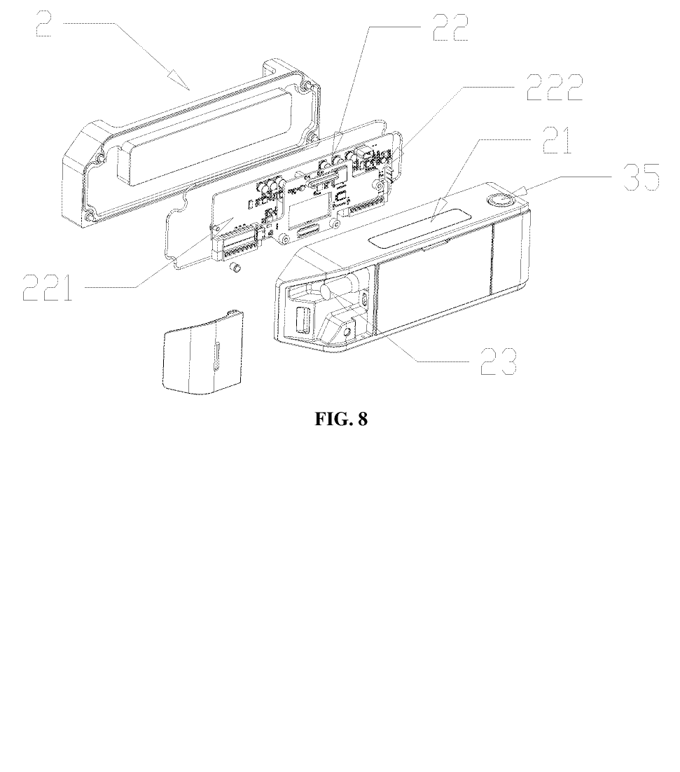

Referring to FIG. 8, the drive assembly 2 includes a drive unit 22 and a power supply unit 23. The drive unit 22 is capable of communicative connection with the control assembly 3 and is electrically connected to the motors of the wheels 11. The power supply unit 23 is used for connecting to a power source and is electrically connected to the drive unit 22. In some aspects, both the drive assembly 2 and the wheels 11 can be provided with plug terminals. Engaging the plug terminals allows the drive assembly 2 to be electrically connected to the hub motors of the wheels 11, thereby enabling the drive assembly 2 to drive the rotation of the wheels 11.

The wheels 11 include a plurality of wheels. In some aspects, the drive unit 22 includes a first drive unit 221 and a second drive unit 222. Two of the wheels 11 are electrically connected to the first drive unit 221 and the second drive unit 222, respectively. With this arrangement, the drive chip of the drive unit 22 can control the rotation of the two wheels 11 via the first drive unit 221 and the second drive unit 222.

In some aspects, the drive assembly 2 can be installed via screws in the bottom storage platform 13, for example at a corresponding end of the bottom storage platform 13 depending on whether it is a front-wheel drive or rear-wheel drive configuration.

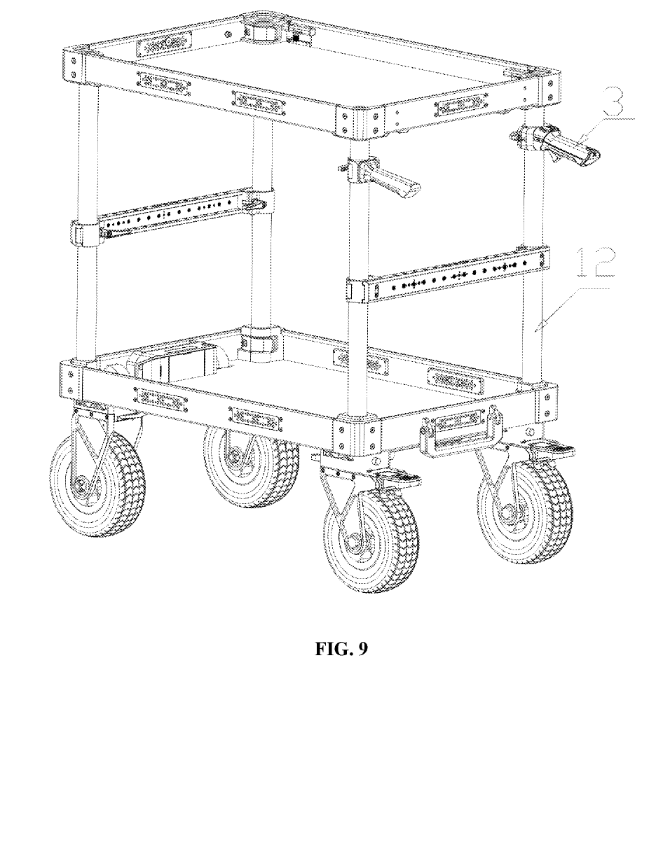

Referring to FIG. 9, in some aspects, the control assembly may include two control handles 3. Each control handle is mounted on a support column 12. Each control handle includes a handle body and a control button arranged on the handle body. The user can grasp the handle body and press the control button to operate the control handle.

Although exemplary embodiments have been described in detail, it should be understood that the invention is not limited to the exemplary configurations and components shown and described. Parts may be substituted, elements may be reversed, and certain features may be used independently of others, all without departing from the scope of the disclosure as defined by the claims. Various alternatives, modifications, and equivalents will be apparent to those skilled in the art. For example, the shape, dimensions, or materials of components may be varied, and mechanical linkages may be replaced with equivalent mechanisms that perform the same function. Such alternatives are considered to be within the scope of the invention as defined by the following claims.

The drawings and the associated descriptions are provided to illustrate embodiments of the invention and are not intended to limit the scope of the invention. Relative terms such as “upper,” “lower,” “left,” “right,” “front,” and “rear” are used for convenience only and are not intended to limit the invention to any particular orientation.

What is claimed is:

1. An electric cart comprising:
a cart body provided with a plurality of wheels;
a drive assembly arranged on the cart body and is electrically connected to one or more of the plurality of wheels; and
a control assembly communicatively connected to the drive assembly, the control assembly being configured to operate the drive assembly to drive one or more of the plurality of wheels to move.

2. The electric cart according to claim 1, wherein the control assembly comprises an operating member and a control unit; and
wherein the control unit is configured to sense an operation instruction from the operating member to control the drive assembly.

3. The electric cart according to claim 2, wherein the control unit comprises a controller and an inductive sensor;
wherein the inductive sensor is electrically connected to the controller;
wherein the operating member comprises an operating part and a trigger part;
wherein the trigger part is connected to the operating part;
wherein the operating part is configured to drive the trigger part to move;
wherein the inductive sensor is configured to sense movement of the trigger part; and
wherein the controller is configured to control the drive assembly according to a sensing signal of the inductive sensor.

4. The electric cart according to claim 3, wherein the cart body is provided with a pushing part;
wherein the controller is arranged on the pushing part; and
wherein the operating part is movably arranged on the pushing part.

5. The electric cart according to claim 4, wherein the inductive sensor comprises a Hall-effect sensor;
wherein the trigger part comprises a magnet;
wherein the magnet is connected to the operating part; and
wherein the Hall-effect sensor is arranged on the pushing part and is arranged opposite to the magnet.

6. The electric cart according to claim 4, wherein the electric cart further comprises an elastic member;
wherein the operating part is provided with an accommodating groove;
wherein the elastic member is arranged in the accommodating groove; and
wherein a first end of the elastic member abuts against or is connected to the pushing part, and a second end of the elastic member abuts against or is connected to the operating part, enabling the operating part to be elastically connected to the pushing part.

7. The electric cart according to claim 4, wherein the cart body comprises a plurality of storage platforms and a plurality of support columns;
wherein the storage platforms are sequentially installed on the support columns along a height direction of the support columns; and
wherein the pushing part is connected to one or more of the plurality of support columns.

8. The electric cart according to claim 7, wherein the pushing part comprises a handle;
wherein the handle comprises a handrail bar and a plurality of connecting rods respectively connected to two ends of the handrail bar;
wherein an end of each of the plurality of connecting rods away from the handrail bar is connected to a corresponding support column of the plurality of support columns;
wherein the main control unit is arranged on the handrail bar; and
wherein the operating part is movably arranged on the handrail bar.

9. The electric cart according to claim 8, wherein the handrail bar comprises a plurality of handrail areas and an installation area;
wherein the installation area is arranged between two of the handrail areas;
wherein the controller is arranged in the installation area; and
wherein the operating part is movably arranged at an end of one of the handrail areas proximate to the installation area.

10. The electric cart according to claim 9, wherein one of the installation area and the operating part facing each other is provided with a limiting groove, and the other one of the installation area and the operating part is provided with a positioning protrusion; and
wherein the positioning protrusion is slidably arranged in the limiting groove.

11. The electric cart according to claim 7, wherein the pushing part is provided with a tube clamp and a locking member;
wherein the tube clamp comprises a first clamping part and a second clamping part; and
wherein a first end of the first clamping part and a first end of the second clamping part are movably connected to each other, and a second end of the first clamping part and a second end of the second clamping part are tightly connected by the locking member.

12. The electric cart according to claim 7, wherein the control assembly comprises two control handles, and each of the two control handles is installed on a corresponding one of the support columns.

13. The electric cart according to claim 4, wherein the pushing part comprises a handle;
wherein the operating part is elastically connected to the handle; and
wherein an outer wall of the operating part is provided with a finger grip.

14. The electric cart according to claim 4, further comprising a control switch;
wherein the control switch is arranged on the pushing part and is electrically connected to the controller; and
wherein the control switch is configured to control the cart body to switch among forward movement, backward movement, and braking.

15. The electric cart according to claim 1, wherein the control assembly is provided with a first communication antenna;
wherein the drive assembly is provided with a second communication antenna; and
wherein the first communication antenna and the second communication antenna are configured to communicate with each other.

16. The electric cart according to claim 1, wherein the drive assembly comprises a drive unit and a power supply unit;
wherein the drive unit is communicatively connectable to the control assembly and is electrically connected to one or more of the plurality of wheels; and
wherein the power supply unit is configured to connect to a power source and is electrically connected to the drive unit.
